(19) United States
(12) Patent Application Publication
(10) Pub. No.: US 2009/0255739 A1
(43) Pub. Date: Oct. 15, 2009

(54) Power wheelchair

(75) Inventor: Chih-Hung Tseng, Taichung (TW)

Correspondence Address: K&L Gates LLP, STATE STREET FINANCIAL CENTER, One Lincoln Street, BOSTON, MA, 02111-2950, US

(73) Assignee: P & F Brother Industrial Corporation, Taichung (TW)

(21) Appl. No.: 12/082,807

(22) Filed: Apr. 14, 2008

(51) Int. Cl. A61G 5/04

(52) U.S. Cl. 180/22; 180/65.1; 180/312

(57) ABSTRACT

A power wheelchair includes a base frame and a seat frame. The base frame includes front and rear frame members, a pair of front wheels connected rotatably to the front frame member, a pair of rear wheels connected rotatably to the rear frame member, and a pair of mid-wheels connected rotatably to the front frame member and disposed between the front and rear wheels. The seat frame is connected to the rear frame member. The rear frame member is connected pivotally to the front frame member, and extends above the front frame member.

### BACKGROUND OF THE INVENTION

1. Field of the Invention

This invention relates to a power wheelchair, more particularly to a power wheelchair that is safe to use.

2. Description of the Related Art

Referring to FIG. 1, a conventional power wheelchair 1 is shown to comprise a front frame 11, a rear frame 12, and a seat frame 13. The front frame 11 includes two spaced-apart support members 111 cooperatively supporting the seat frame 13, and two spaced-apart mid-wheels 112 and two spaced-apart front wheels 113 (only one of each of the mid-wheels 112 and the front wheels 113 is visible). The rear frame 12 is connected pivotally to and is disposed below the front frame 11 through a pivot shaft 123. The rear frame 12 is provided with two spaced-apart rear wheels 122 (only one is visible).

Although the conventional power wheelchair 1 can achieve its intended purpose, in actual use, it has the following drawbacks:

1. When the front wheels 113 encounter a slope, the front frame 11 inclines unstably, thereby adversely affecting the balance of the seat frame 13, so that the power wheelchair 1 is likely to tip over. Hence, the power wheelchair 1 is unsafe to use.

2. The front frame 11 reacts immediately upon encountering a bump, and the impact is directly transferred to the seat frame 13, thereby adversely affecting the comfort of the user.

### SUMMARY OF THE INVENTION

Therefore, the object of the present invention is to provide a power wheelchair that can be used safely and comfortably.

According to this invention, a power wheelchair comprises a base frame and a seat frame. The base frame includes front and rear frame members, a pair of front wheels connected rotatably to the front frame member, a pair of rear wheels connected rotatably to the rear frame member, and a pair of mid-wheels connected rotatably to the front frame member and disposed between the front and rear wheels. The rear frame member is connected pivotally to the front frame member. The seat frame is connected to the rear frame member.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic side view of a conventional power wheelchair;

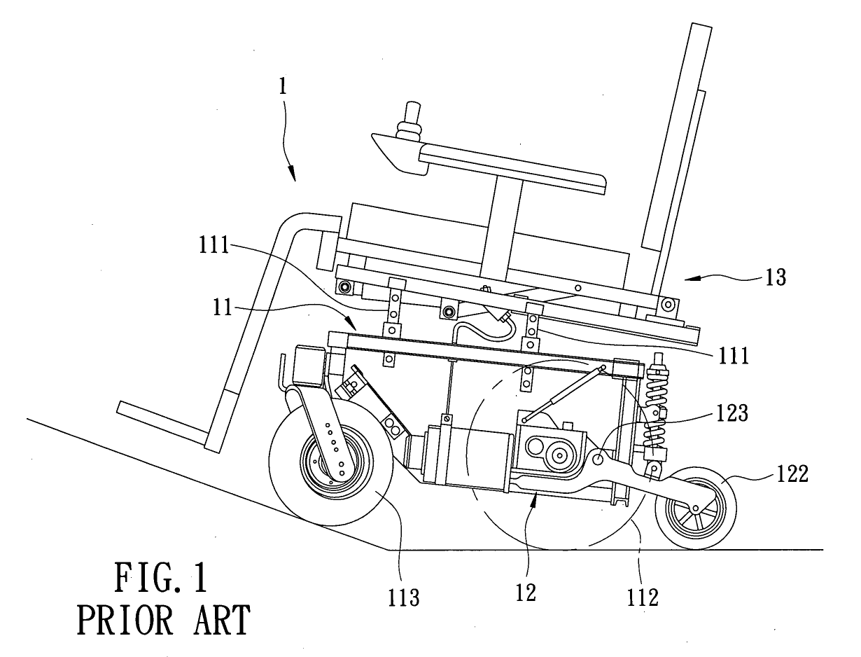

FIG. 2 is a perspective view of a power wheelchair according to the preferred embodiment of this invention;

FIG. 3 is a schematic side view of the preferred embodiment;

FIG. 4 is a view similar to FIG. 3, but illustrating the power wheelchair of the present invention encountering an upward slope; and

FIG. 5 is a view similar to FIG. 3, but illustrating the power wheelchair of the present invention encountering a downward slope.

### DETAILED DESCRIPTION OF THE PREFERRED EMBODIMENT

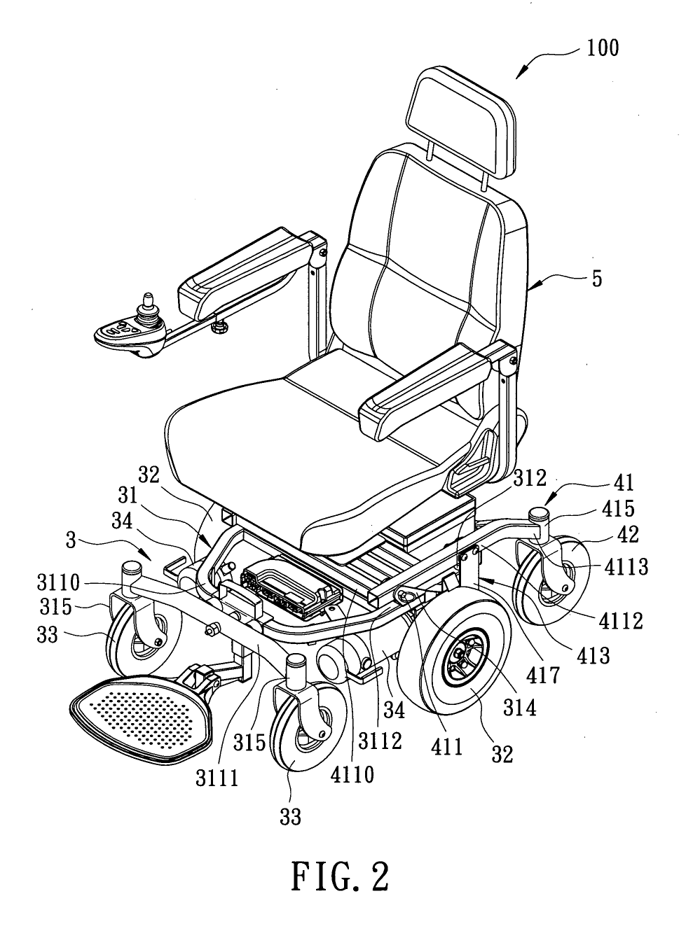

Referring to FIGS. 2 to 5, a power wheelchair 100 according to the preferred embodiment of the present invention is shown to comprise a base frame 3 and a seat frame 5.

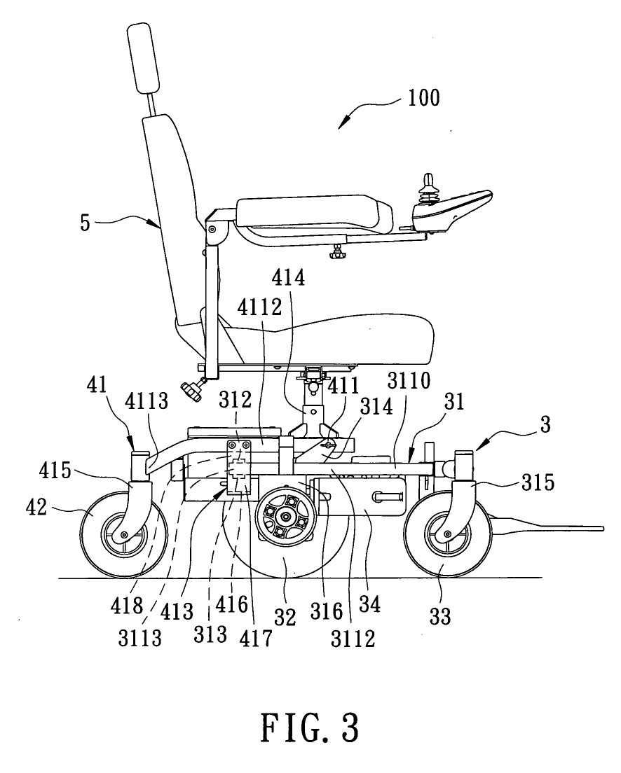

The base frame 3 includes front and rear frame members 31, 41, a pair of spaced-apart front wheels 33, a pair of spaced-apart rear wheels 42, and a pair of spaced-apart mid-wheels 32. The front frame member 31, in this embodiment, has a front end provided with a front wheel support rod 3111 and a substantially U-shaped rod 3110 connected pivotally to the front wheel support rod 3111. The U-shaped rod 3110 has left and right side rods 3112 provided respectively at left and right lateral sides of the front frame member 31 and having rod ends 3113 (only one is visible in FIGS. 3 to 5) that extend to a rear end of the front frame member 31. The front wheel support rod 3111 is provided with a pair of front wheel seats 315 to mount rotatably and respectively the front wheels 33. The rod end 3113 of each side rod 3112 is provided with upper and lower shock-absorbing pads 312, 313. Two pivot plates 314 extend upwardly, inclinedly, and respectively from the left and right side rods 3112 proximate to the rear end of the front frame member 31. Two mid-wheel seats 316 are connected respectively to the left and right side rods 3112 in proximity to the rod ends 3113 to mount rotatably and respectively the mid-wheels 32.

The rear frame member 41, in this embodiment, has a front connecting rod 4110 provided at a front end thereof, and left and right side rods 4112 provided respectively at left and right lateral sides of the rear frame member 41 and connected respectively to left and right ends of the connecting rod 4110. The left and right side rods 4112 are further connected pivotally and respectively to the pivot plates 314 in proximity to the front connecting rod 4110 through a pivot shaft 411, so that the front and rear frame members 31, 41 are connected pivotally to each other. The left and right side rods 4112 have rod ends 4113 extending into a rear end of the rear frame member 41 and provided respectively with two rear wheel seats 415 to mount rotatably and respectively the rear wheels 42. The mid-wheels 32 are disposed between the front and rear wheels 33, 42. The left and right side rods 4112 overlap respectively the left and right side rods 3112. Each of the left and right side rods 4112 is provided with a limiting member 413 to limit a pivot movement of the front frame member 31 relative to the rear frame member 41. The limiting member 413 includes two side plates 417 (only one is visible) having top ends screwed respectively to inner and outer faces of the corresponding side rod 4112, and a bottom plate 416 interconnecting the side plates 417 and opposite to the corresponding side rod 4112. The bottom plate 416, the side plates 417, and the corresponding side rod 4112 cooperatively define a limiting space 418. The rod end 3113 of each side rod 3112 extends into the limiting space 418, and is movable upwardly and downwardly within the limiting space 418.

A supporting tube 414 extends upwardly from the rear frame member 41 between the lateral sides thereof. The seat frame 5 is supported by the supporting tube 414.

In this embodiment, the power wheelchair 100 further comprises two motors 34 connected to and disposed below the front frame member 31 so as to drive respectively the mid-wheels 32.

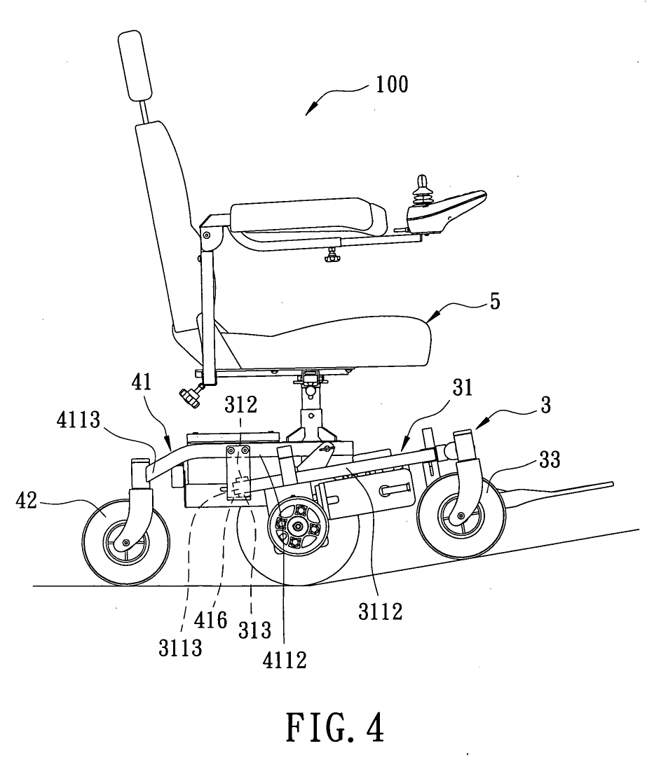

With reference to FIG. 4, when the power wheelchair 100 encounters an upward slope, the rear end of the front frame member 31 pivots downwardly relative to the rear frame member 41, and the front wheels 33 move upward and towards the seat frame 5 until the lower shock-absorbing pads 313 on the rod ends 3113 of the side rods 3112 abut respectively against the bottom plates 416 of the limiting members 413 of the side rods 4112.

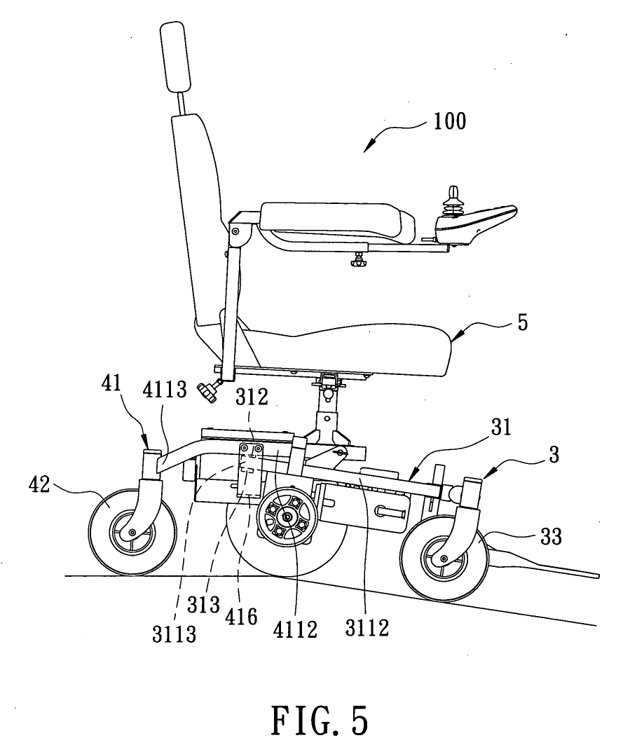

With reference to FIG. 5, when the power wheelchair 100 encounters a downward slope, the rear end of the front frame member 31 pivots upwardly relative to the rear frame member 41, and the front wheels 33 move away from the seat frame 5 until the upper shock-absorbing pads 312 on the rod ends 3113 of the side rods 3112 abut respectively against the side rods 4112.

Hence, regardless of whether the power wheelchair 100 encounters an upward or downward slope, or a bump or an indentation on the surface of the ground, the front and rear wheels 33, 42 and the mid-wheels 32 can move stably and easily on the ground in conformity with the ground surface.

From the aforementioned description, the advantages of the power wheelchair 100 of the present invention may be summarized as follows:

1. When the front wheels 33 encounter a slope, the front frame member 31 pivots immediately to incline with respect to the rear frame member 41. Since the seat frame 5 is supported on the rear frame member 41 by the supporting tube 414, the seat frame 5 does not immediately incline, so that the center of gravity of the seat frame 5 will not suddenly change. As such, the possibility of the power wheelchair 100 being tipped over is minimized, thereby enhancing the safety of the power wheelchair 100.

2. When the front frame member 31 encounters a bump, it rides over the bump. This reaction is not directly transferred to the seat frame 5, so that the power wheelchair 100 is stable and comfortable.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A power wheelchair comprising:
a base frame including front and rear frame members, a pair of front wheels connected rotatably to said front frame member, a pair of rear wheels connected rotatably to said rear frame member, and a pair of mid-wheels connected rotatably to said front frame member and disposed between said front and rear wheels, said rear frame member being connected pivotally to said front frame member; and
a seat frame connected to said rear frame member.

2. The power wheelchair of claim 1, wherein said rear frame member extends above said front frame member.

3. The power wheelchair of claim 2, wherein said front frame member has a rear end, and left and right lateral sides provided respectively with pivot plates that extend upwardly from said front frame member proximate to said rear end, and said rear frame member has a front end, and left and right lateral sides overlapping said front frame member and connected pivotally and respectively to said pivot plates in proximity to said front end of said rear frame member.

4. The power wheelchair of claim 3, wherein said front frame member further has a front end provided with a pair of front wheel seats to mount said front wheels, respectively.

5. The power wheelchair of claim 4, wherein said rear frame member further has a rear end provided with a pair of rear wheel seats to mount said rear wheels, respectively.

6. The power wheelchair of claim 5, wherein said front frame member further has a pair of mid-wheel seats provided in proximity to said rear end of said front frame member to mount said mid-wheels, respectively.

7. The power wheelchair of claim 6, wherein said rear frame member is provided with a limiting member to limit a movement of said front frame member relative to said rear frame member.

8. The power wheelchair of claim 7, wherein said limiting member includes a limiting space, said front frame member having a rod end extending into said limiting space at said rear end of said front frame member and movable upwardly and downwardly within said limiting space.

9. The power wheelchair of claim 8, wherein said limiting member further includes two opposite side plates having top ends connected to said rear frame member, and a bottom plate interconnecting said side plates and opposite to said rear frame member, said bottom and side plates and said rear frame member cooperatively defining said limiting space.

10. The power wheelchair of claim 9, wherein said rod end of said front frame member is provided with upper and lower shock-absorbing pads, said lower shock-absorbing pad abutting against said bottom plate when said rod end of said front frame member pivots downwardly, said upper shock-absorbing pad abutting against said rear frame member when said rod end of said front frame member pivots upwardly.

11. The power wheelchair of claim 2, wherein said rear frame member further has a supporting tube that extends upwardly from said rear frame member to support said seat frame.

12. The power wheelchair of claim 1, further comprising at least one motor connected to and disposed below said front frame member to drive said mid-wheels to rotate.
